(19) United States
(12) Patent Application Publication
(10) Pub. No.: US 2021/0032168 A1
(43) Pub. Date: Feb. 4, 2021

(54) CERAMIC MATERIAL, LAYER AND LAYER SYSTEM

(71) Applicant: Siemens Aktiengesellschaft, Munich (DE)

(72) Inventors: Arturo Flores Renteria, Berlin (DE); Werner Stamm, Mülheim an der Ruhr (DE)

(73) Assignee: Siemens Aktiengesellschaft, Munich (DE)

(21) Appl. No.: 16/976,248

(22) PCT Filed: Feb. 12, 2019
(86) PCT No.: PCT/EP2019/053383

§ 371 Date: Aug. 27, 2020

(30) Foreign Application Priority Data
Mar. 14, 2018 (DE) 10 2018 203 895.3

(51) Int. Cl. C04B 35/48; C04B 41/50; C04B 41/87; C23C 28/04; C23C 28/00; C04B 41/00

(52) U.S. Cl. CPC C04B 35/48; C04B 41/5042; C04B 41/87; C04B 2235/3246; C23C 28/3455; C04B 41/009; C04B 2235/3225; C23C 28/042

(57) ABSTRACT

A ceramic material which contains yttrium oxide as the stabilizer and at least one of the materials erbium oxide or ytterbium oxide provides a phase having sintering stability for a ceramic material for ceramic layers and a ceramic layer system which maintain the mechanical and thermal properties for a long time even when used at high temperatures.

### CROSS REFERENCE TO RELATED APPLICATIONS

This application is the US National Stage of International Application No. PCT/EP2019/053383 filed 12 Feb. 2019, and claims the benefit thereof. The International Application claims the benefit of German Application No. DE 10 2018 203 895.3 filed 14 Mar. 2018. All of the applications are incorporated by reference herein in their entirety.

### FIELD OF INVENTION

The invention relates to a ceramic material based on zirconium oxide with stabilizers, a layer and a layer system composed thereof.

### BACKGROUND OF INVENTION

Turbine blades or components in general for high-temperature use are often provided with thermal barrier coatings. These are usually ceramic thermal barrier coatings based on zirconium oxide, fully or partially stabilized or based on pyrochlores, for example gadolinium zirconate.

Requirements which the ceramic thermal barrier coating has to meet are not only a low thermal conductivity but also a high fracture toughness and low sintering tendency, so that mechanical stresses can also be withstood over time.

### SUMMARY OF INVENTION

It is therefore an object of the invention to provide a ceramic material which solves these problems.

The object is achieved by a ceramic material, a layer and a layer system as claimed.

### BRIEF DESCRIPTION OF THE DRAWINGS

FIGS. 1, 2 schematically show a layer system on the basis of the invention.

### DETAILED DESCRIPTION OF INVENTION

The figures and the description present working examples.

The ceramic material has a tetragonal and cubic crystal structure which depends on the proportion of the stabilizer yttrium oxide. The tetragonal phase is stabilized by the proportion of yttrium oxide.

The ceramic material based on zirconium oxide (ZrO₂) contains yttrium oxide (Y₂O₃) and also at least one further, in particular two further, very particularly only two further, oxides selected from the group consisting of erbium oxide (Er₂O₃) and ytterbium oxide (Yb₂O₃), which advantageously act as stabilizers.

The proportion of the yttrium oxide (Y₂O₃) is advantageously 4 mol %-16 mol %, while the proportion of the further oxides is, in particular, 2 mol %-40 mol %.

Advantage is given to using 2 mol %-40 mol % of erbium oxide (Er₂O₃) and/or ytterbium oxide (Yb₂O₃), in particular 5 mol %-32 mol % of erbium oxide (Er₂O₃) and ytterbium oxide (Yb₂O₃).

The proportion of erbium oxide (Er₂O₃) and/or ytterbium oxide (Yb₂O₃) is advantageously 2 mol %-20 mol % of erbium oxide (Er₂O₃).

When use is made of advantageously 4 mol %-10 mol % of erbium oxide (Er₂O₃), an amount of, in particular, 6 mol %-16 mol % of yttrium oxide (Y₂O₃) is used.

When use is made of advantageously 4 mol %-10 mol % of ytterbium oxide (Yb₂O₃), an amount of, in particular, 6 mol %-16 mol % of yttrium oxide (Y₂O₃) is used.

A ceramic layer can be produced from this ceramic material. To produce the layer, it is possible to use all coating methods known from the prior art, for example plasma spraying (APS, VPS, LPPS, . . . ) or HVOF.

A ceramic layer composed of this ceramic material has, in particular, a thickness of 20 μm, in particular from 200 μm to 2000 μm, and is produced by atmospheric plasma spray. The layer can likewise be produced by an EBPVD process and then advantageously has a layer thickness of from 20 μm to 1000 μm.

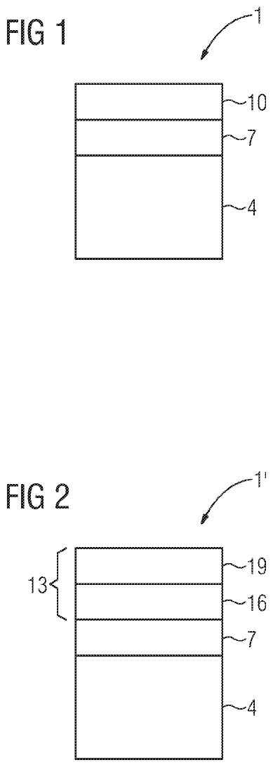

The ceramic layer can be applied as single layer (FIG. 1) or as double layer (FIG. 2) in the layer system.

FIG. 1 shows a layer system 1 comprising a substrate 4. The substrate 4 is advantageously metallic and advantageously a nickel- or cobalt-based superalloy. The substrate 4 can likewise be made of ceramic and in particular can comprise a CMC material.

A bonding layer 7 is present on the substrate 4. In the case of a metallic material, this is advantageously an NiCoCrAlY layer 7.

A single layer 10 composed of the ceramic material according to the invention is then present on the bonding layer 7.

FIG. 2 shows a further layer system 1′ in which the single layer is replaced by a double layer 13 made up of an inner layer 16, in particular based on partially yttrium-stabilized zirconium oxide but different from the material of the outer layer, and an outer layer 19 based on the ceramic material of the invention.

The ceramic bonding layer 16 located at the bottom is advantageously a partially stabilized yttrium oxide-zirconium oxide layer, in particular with 3 mol %-4 mol % of yttrium oxide (Y₂O₃).

In both cases (FIGS. 1, 2), at least the outer ceramic layer 10, 19 can be segmented (DVC).

1. A ceramic material comprising:
zirconium oxide (ZrO₂) with yttrium oxide (Y₂O₃) and at least one further oxide selected from the group consisting of: erbium oxide (Er₂O₃) and ytterbium oxide (Yb₂O₃).

2. The ceramic material as claimed in claim 1,
wherein only yttrium oxide (Y₂O₃), erbium oxide (Er₂O₃) and ytterbium oxide (Yb₂O₃) are used as oxides.

3. The ceramic material as claimed in claim 1,
wherein only yttrium oxide (Y₂O₃) erbium oxide (Er₂O₃) are used as oxides.

4. The ceramic material as claimed in claim 1,
wherein only yttrium oxide (Y₂O₃) and ytterbium oxide (Yb₂O₃) are used as oxides.

5. The ceramic material as claimed in claim 1, comprising:
4 mol %-16 mol % of yttrium oxide (Y₂O₃).

6. The ceramic material as claimed in claim 1, comprising:
2 mol %-40 mol % of erbium oxide (Er₂O₃) and/or ytterbium oxide (Yb₂O₃).

7. The ceramic material as claimed in claim 1, comprising
2 mol %-20 mol % of erbium oxide (Er₂O₃).

8. The ceramic material as claimed in claim 1, comprising
2 mol %-20 mol % of ytterbium oxide (Yb₂O₃).

9. The ceramic material as claimed in claim 1, comprising
4 mol %-10 mol % of erbium oxide (Er₂O₃).

10. The ceramic material as claimed in claim 1, comprising
4 mol %-10 mol % of ytterbium oxide (Yb₂O₃).

11. A ceramic layer, comprising:
a ceramic material as claimed in claim 1.

12. The ceramic layer as claimed in claim 11,
produced by APS and having a layer thickness of from 20 μm to 2000 μm.

13. The ceramic layer as claimed in claim 11,
produced by EB-PVD and having a layer thickness of from 20 μm to 1000 μm.

14. A layer system comprising at least
a substrate, metallic or ceramic,
a bonding layer, either metallic or ceramic,
at least one layer composed of the ceramic material as claimed in claim 1.

15. The layer system as claimed in claim 14,
wherein a ceramic bonding layer is present between an outer layer, with the bonding layer comprising partially yttrium-stabilized zirconium oxide.

16. The layer system as claimed in claim 15,
wherein at least the outer ceramic layer is segmented.

17. The ceramic material as claimed in claim 5, comprising:
6 mol %-16 mol % of yttrium oxide (Y₂O₃).

18. The ceramic material as claimed in claim 6, comprising:
5 mol %-32 mol % of erbium oxide (Er₂O₃) and/or ytterbium oxide (Yb₂O₃).

19. The ceramic material as claimed in claim 9, comprising:
6 mol %-16 mol % of erbium oxide (Er₂O₃).

20. The ceramic material as claimed in claim 10, comprising:
6 mol %-16 mol % of yttrium oxide (Y₂O₃).

21. A ceramic layer, consisting of:
the ceramic material as claimed in claim 1.

22. The layer system as claimed in claim 15,
wherein the bonding layer consisting of yttrium-stabilized zirconium oxide.
